(19) United States
(12) Patent Application Publication
(10) Pub. No.: US 2008/0120866 A1
(43) Pub. Date: May 29, 2008

(54) Personal Drying Apparatus

(76) Inventor: Stephen BALL, Wimborne (GB)

Correspondence Address: Richard P. Beem, Suite 1352, 53 W. Jackson Blvd., Chicago, IL, 60604, US

(21) Appl. No.: 11/942,920

(22) Filed: Nov. 20, 2007

(30) Foreign Application Priority Data
Nov. 23, 2006 (GB) 0623383.7

(51) Int. Cl. F26B 3/32; F26B 19/00

(52) U.S. Cl. 34/267; 34/202; 34/266

(57) ABSTRACT

A personal drying apparatus comprises a casing, an air heater in the casing, two fans, one to each side of the casing, for blowing two parallel streams of air heated by the air heater onto the person to be dried from two heated air outlets located in the front of the casing, an air intake located in the casing between the heated air outlets and an infra-red source for directing the infra-red rays onto the person being dried to supplement the drying achieved by the heated air flow.

### FIELD OF THE INVENTION

This invention relates to a personal drying apparatus.

### BACKGROUND OF THE INVENTION

The present invention is intended for use in such places as care homes, hospitals, domestic environments, hotels and leisure facilities. The idea is, to provide a personal drying apparatus which can be situated within a shower cubicle, over or adjacent to a bath or positionable over a bed. In this way it could be used instead of towels for when people have had showers, baths or bed baths.

The use of this equipment has the advantage that, in negating the use of towels, laundry costs are reduced an hygiene is increased.

Units are present on the market today but these units have problems about effectiveness, slow warm up, slow drying, difficult installation, noisy or energy inefficient.

The present invention seeks to provide a personal drying apparatus which reduces or obviates some or all of the above disadvantages.

### SUMMARY OF THE INVENTION

According to the invention, a personal drying apparatus comprises a casing, an air heater in the casing, two fans, one to each side of the casing, for blowing two parallel streams of air heated by the air heater onto the person to be dried from two heated air outlets located in the front of the casing, an air intake located in the casing between the heated air outlets and an infra-red source for directing the infra-red rays onto the person being dried to supplement the drying achieved by the heated air flow.

The fans may be long impeller fans.

The infra red source may comprise an infra-red lamp tube extending in a direction parallel to the longitudinal axis of the fans and two infra-red tubes may be provided, each located between one heated air outlet and the air intake.

Four fans may be provided in two pairs, each fan in a pair having coaxial axes.

At least four infra red tubes may be provided in two pairs arranged coaxially.

A filter may be provided adjacent to the air intake and between the air intake and the fans.

A cooling arrangement may be provided for cooling and dehumidifying the air from the air intakes.

A hood may be provided for location over the person being dried for the extraction of some or all of the air from the region containing the person being dried.

### BRIEF DESCRIPTION OF THE DRAWINGS

The invention will now be described in greater detail by way of examples with reference to the drawings, in which:—

FIG. 1 is a schematic perspective view of a drying apparatus in accordance with the invention suitable for use in a shower;

FIG. 2 is a schematic underneath sectional view of a drying apparatus in accordance with the invention, suitable for use in the set up of FIG. 1;

FIG. 3 is a schematic elevational view of the drying; apparatus of a FIG. 2;

FIG. 4 is a sectional plan view of the setup of FIGS. 2 and 3 as applied to a shower arrangement having a single sided modesty screen;

FIG. 5 is a view similar to FIG. 4 but showing a dual construction of drying apparatus with modesty screens and/or doors, and

FIG. 6 is a schematic perspective arrangement of a drying unit in accordance with the invention suitable for removable and adjustably positioning over a bed or similar area.

### DESCRIPTION OF THE PREFERRED EMBODIMENTS

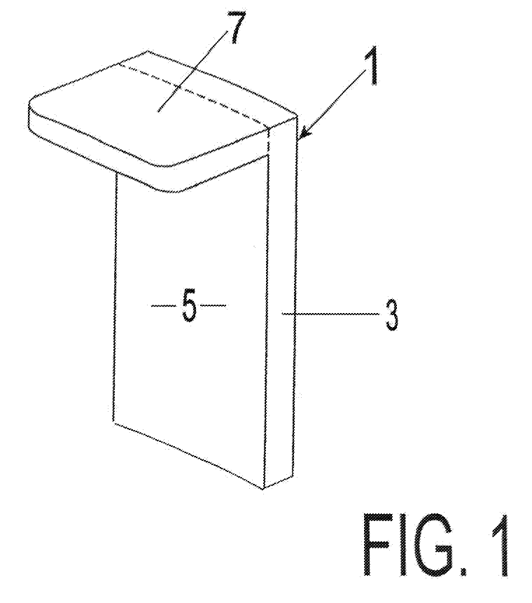

Referring firstly to FIG. 1, a personal drying unit 1 in accordance with one embodiment of the invention is enclosed in an enclosures 3 which stands vertically with its operative face 5 facing the area in which a person to be dried would stand. Extending over some or all of this area is an optional hood 7 which is used to collect some of the heated air after it has passed over the person being dried. This collected air can be filtered and returned to the drying air system or can be exhausted to atmosphere as desired. Warm air is collected through suitable vents in the operative face 5 for re-circulation, whether the hood is present or not, as will be discussed hereafter.

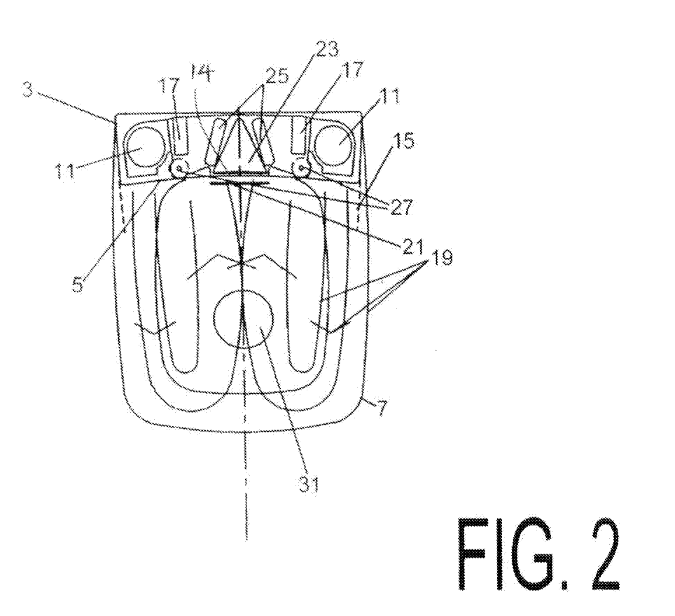

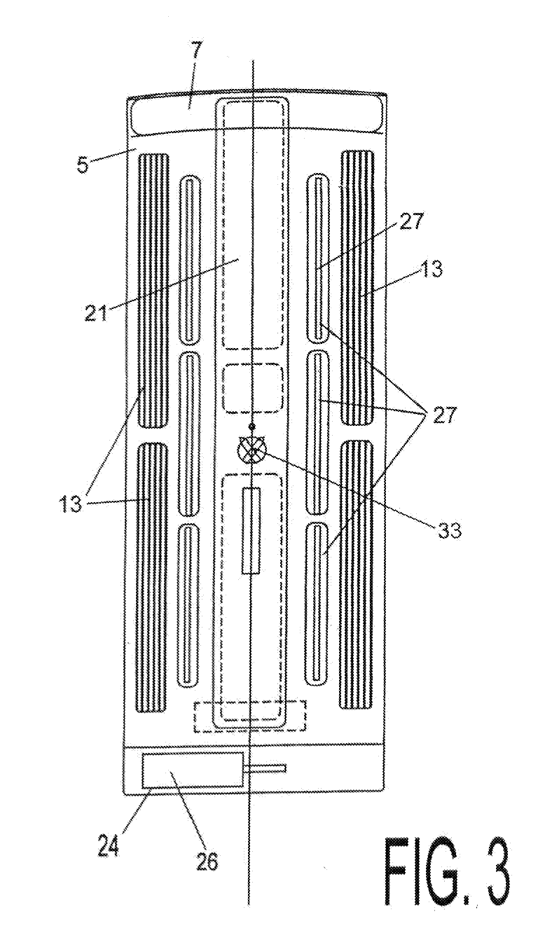

FIGS. 2 and 3 show the construction and arrangement of the operative parts of the drying apparatus suitable for use in the set up of FIG. 1. Air flow is controlled by two pairs of vertically orientated long impeller fans 11, one pair of fans 11 being located at either side of the enclosure 3 and the fans 11 in each pair being located, one above the other so as to provide vertically orientated outlets in the form of outlet vents 13. Thus the air is guided by the fan scroll configuration and possibly also by optional diverter wings 15 (shown only in FIG. 2). These, wing 15 will also act as shields to reduce mixing of ambient air with the heated air.

The air, which is heated prior to entry into the impeller fans by heaters 17, flows outwardly from, the operative face 5 and then passes inwards and back to the centre of the operative face 5 in the pattern as shown by the lines and arrows 19 as shown in FIG. 2. Additionally, warm air may be collected by the hood 7, if fitted.

The air flowing back to the operative face 5 passes around a baffle 21 and back into the enclosure 3 through an air intake 14 to pass through a triangular air filter 23, through two optional cooling coils 25 and back to the fans 11 by way of the heaters 17. While there will be some reaction with the air surrounding the air flow, the main airflow, including where so desired, some or all of the air extracted by the hood 7, will re-circulate. The cooling coils 25, when present, will be supplied by at cooling unit 24, including a compressor 26, which would be built into the base of the apparatus as shown briefly in FIG. 3. The heat produced by the refrigeration process may be supplied to additionally heat the re-circulated, air. Control of the cooling unit may be carried out using a humidity sensor (not shown) provided at the air intake which will cut off the cooling unit it the re-circulating air is sensed as being dry enough.

In addition to the heated air flow, two sets of infra-red heating lamps 27 are provided to give additional, heat for drying. As shown, these are provided in two banks of three, each bank providing a line of vertically arranged elongated tubes 27.

In order to prevent the infra red apparatus and the adjacent equipment overheating, the air from the cooling coils 25 provides cooling of the enclosure 3 before passing back through the heaters 17. Also, the housing of the infra-red lamps 27 is perforated and a portion of the cooled air passes through the lamp housing to keep the lamps at the required operating temperature, this air then being returned to the heaters through a baffle arrangement (not shown).

As explained, the personal drying apparatus of this embodiment of the invention is positioned in a shower cubical with the shower head 31 located beneath the hood 7. Controls for the shower and for the control of the drying apparatus, i.e. temperature of the air flow, air flow rate etc. are mounted on the air baffle as shown at 33. However, it will be appreciated that the personal drying apparatus may be used in a stand alone function as a separate drying installation.

As will be seen from the drawing of FIG. 2, a person standing in the shower cubicle beneath the shower head will have warm air blown around him and he will additionally be warmed by the infrared lamps providing a fast drying operation. With this arrangement, efficient drying is achieved at a relatively fast speed thus only using the minimum of electricity to carry this out.

It will be understood that, while the above described apparatus is located in a shower cubicle, it could equally well be located in a separate drying area or could be associated with a bath, for example.

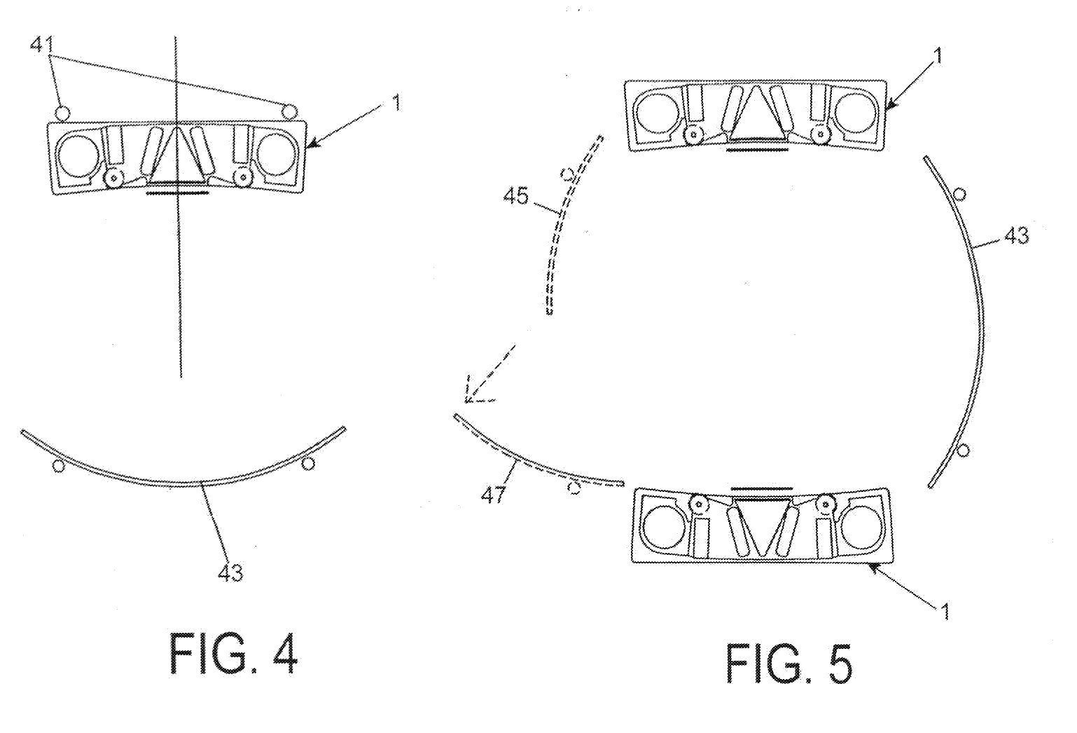

Two ways in which the apparatus above described could be used in a shower environment, particularly where a number of showers are provided together is shown in FIGS. 4 and 5

In the first case (FIG. 4), the apparatus 1 is provided behind the shower area, suitably carried by vertical supports 41 with the area in front of the shower area being closed off by a modesty screen 43, leaving the sides of the shower area open for access.

In the second case (FIG. 5) two drying units 1 are used opposite each other on opposite sides of the shower area. In the case shown, one side of the shower area is blocked off by a modesty screen while the other side has a modesty screen 45 with an opening door 47.

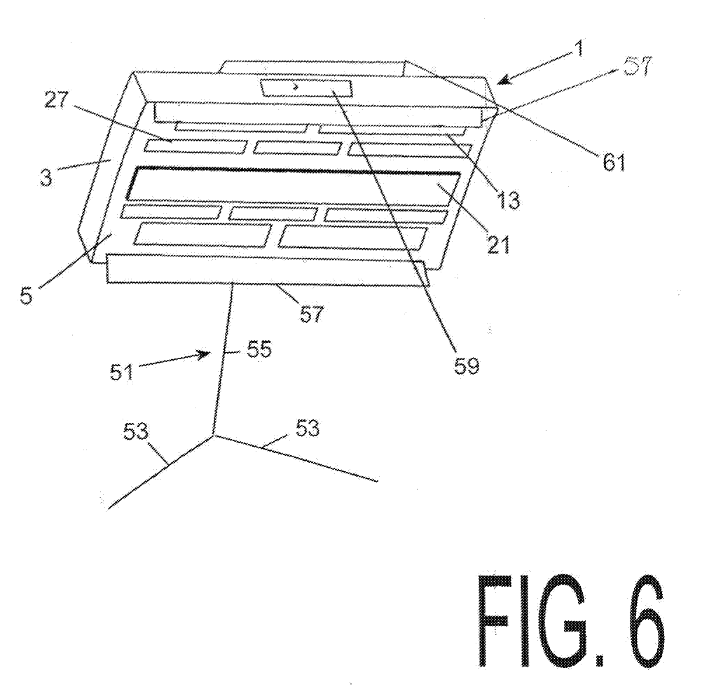

FIG. 6 shows a version of the personal drying apparatus suitable for use in drying an hospital patient after a bed bath. In this case, the enclosure 3 of the drying unit 1 is mounted on a frame, indicated only schematically at 51 and comprising a pair of base feet 53, a suitable upright 55, the upper end of which supports the enclosure 3 so that the enclosure 3 is pivotally mounted thereon about an horizontal balancing pivot. The feet 53 may be suitably mounted on castors to enable the drying apparatus 1 to be mobile.

The construction of the unit itself is the same as for the stationary units but it has its controls located on a side panel 59 instead of on the air baffle 21 and is provided with a handle 61 by means of which the orientation of the unit 1 can be adjusted. Additionally, baffles 57 are provided on opposite sides of the unit to assist in properly directing the airflow.

It will be appreciated that various modifications of or additions to the above described embodiments may be made without departing from the scope of the invention For example, the number of impeller fans could be varied so that only a single fan could be provided on each side. On the other hand, three or more units could be used on each side. Similarly, the number of infra red units in each bank could be varied to less or more than the three lamps described. Thus one or two lamps per bank could be used or four or more lamps per bank could be utilised.

It desired, a coin operated mechanism may be used for controlling the drying apparatus, the mechanism being located either on the baffle 21 or separately from the unit itself. A timer may be incorporated in the unit, together with or without the coin operated mechanism.

The position of the unit can be varied from the positions shown. For example, with certain types of shower unit, the drying apparatus could be located across a corner of the shower unit. Where two units are used, the units could be located, instead of facing each other, be arranged on adjacent sides at right angles to each other. In yet another arrangement, the unit could be located above the shower unit so that the drying air flows downwardly into the shower area.

1. A personal drying apparatus comprising a casing, an air heater in said casing, two fans in said casing, one to each side of said casing, and adapted to blowing two parallel streams of air heated by said air heater onto a person to be dried, two heated air outlets located in the front of the casing conducting said two parallel streams of air out of said casing, an air intake located in said casing between said heated air outlets and an infra-red source directing infra-red rays onto the person being dried to supplement the drying achieved by the heated air flow.

2. An apparatus as claimed in claim 1, wherein said fans are long impeller fans.

3. An apparatus as claimed in claim 2, wherein said fans each have a longitudinal axis and said infra red source comprises an infra-red lamp tube extending in a direction parallel to said longitudinal axis of said fans.

4. An apparatus as claimed in claim 3 wherein two said infra-red tubes are provided, each located between one of said heated air outlets and said air intake.

5. An apparatus as claimed in claim 4, wherein four said fans are provided in two pairs, each fan in a pair having coaxial axes.

6. An apparatus as claimed in claim 5, wherein at least four said infra red tubes are provided in two pairs arranged coaxially.

7. An apparatus as claimed in claim 6, wherein a filter is provided adjacent to said air intake and between said air intake and said fans.

8. An apparatus as claimed in claim 7, wherein a cooling arrangement is provided cooling and dehumidifying air from said air intake.

9. An apparatus as claimed in claim 8, wherein a hood is located over the person being dried for the extraction of some or all of the air from a region containing the person being dried.
